(19) United States
(12) Patent Application Publication
(10) Pub. No.: US 2009/0093667 A1
(43) Pub. Date: Apr. 9, 2009

(54) Method for lead bearing material surface molecular stabilization

(76) Inventor: Keith E. Forrester, Meredith, NH (US)

Correspondence Address: Keith E. Forrester, 78 Tracy Way, Meredith, NH, 03253, US

(21) Appl. No.: 11/999,964

(22) Filed: Dec. 7, 2007

Related U.S. Application Data
(60) Provisional application No. 60/997,565, filed on Oct. 4, 2007.

(51) Int. Cl. A62D 3/33

(52) U.S. Cl. 588/315

(57) ABSTRACT

This invention provides a method for stabilization and complexing of lead bearing material surfaces subject to acid and water leaching tests or leach conditions by addition of stabilizing and complexing agents such that leaching and mobility potential is inhibited to desired levels. The resultant material or waste after stabilization is deemed suitable for on-site reuse, off-site reuse or disposal as RCRA non-hazardous waste, and has reduced Pb bioavailability and reduced groundwater solubility.

### BACKGROUND OF THE INVENTION

Lead painted surfaces on house trim, house siding, walls, toys, chairs, and other objects; lead bearing surfaces in water distribution piping such as solder joints; lead bearing PVC wire insulation; lead bearing and lead stabilizer (i.e. lead stearate) bearing plastic toys, chairs, objects; and combinations of lead bearing materials and wastes, may be deemed “Hazardous Waste” by the United States Environmental Protection Agency (USEPA) pursuant to 40 C.F.R. Part 261 Resource Conservation and Recovery Act (RCRA) and also deemed hazardous under similar regulations in other countries such as Japan, Switzerland, Mexico, Australia, Canada, Taiwan, European Countries, India, and China, and deemed special waste within specific regions or states within those countries, if containing leachable lead above levels deemed hazardous by those country, regional or state regulators. These Pb bearing materials can also be regulated under OSHA, Clean Water Act (NPDES), Clean Air Act (CAA) and other health related protection laws due to the potential of the lead exposure by direct of indirect ingestion or inhalation and subsequent toxicity to humans and the environment.

In the United States, any solid waste can be defined as Hazardous Waste either because it is “listed” in 40 C.F.R., Part 261 Subpart D, federal regulations adopted pursuant to the Resource Conservation and Recovery Act (RCRA), or because it exhibits one or more of the characteristics of a Hazardous Waste as defined in 40 C.F.R. Part 261, Subpart C. The hazard characteristics defined under 40 CFR Part 261 are: (1) ignitability, (2) corrosivity, (3) reactivity, and (4) toxicity as tested under the Toxicity Characteristic Leaching Procedure (TCLP). 40 C.F.R., Part 261.24(a), contains a list of heavy metals and their associated maximum allowable concentrations. If a heavy metal, such as lead, exceeds its maximum allowable concentration from a solid waste, when tested using the TCLP analysis as specified at 40 C.F.R. Part 261 Appendix 2, then the solid waste is classified as RCRA Hazardous Waste. The USEPA TCLP test uses a dilute acetic acid either in de-ionized water (TCLP fluid 2) or in de-ionized water with a sodium hydroxide buffer (TCLP fluid 1). Both extract methods attempt to simulate the leachate character from a decomposing trash landfill in which the solid waste being tested for is assumed to be disposed in and thus subject to rainwater and decomposing organic matter leachate combination . . . or an acetic acid leaching condition. Waste containing leachable Pb is currently classified as hazardous waste due to the toxicity characteristic, if the level of TCLP analysis is above 5.0 milligrams per liter (mg/L). The TCLP test is designed to simulate a worst-case leaching situation . . . that is a leaching environment typically found in the interior of an actively degrading municipal landfill. Such landfills normally are slightly acidic with a pH of approximately 5±0.5. Countries outside of the U.S. also use the TCLP test as a measure of leaching such as China, Taiwan, Mexico, and Canada. Switzerland and Japan regulate management of solid wastes by measuring Pb and salts as tested by a sequential leaching method using carbonated water simulating rainwater and de-ionized water sequential testing. Additionally, U.S. EPA land disposal restrictions prohibit the land disposal of solid waste leaching in excess of maximum allowable concentrations upon performance of the TCLP analysis. The land disposal regulations require that hazardous wastes are treated until Pb does not leach at levels from the solid waste at levels above the maximum allowable concentrations prior to placement in a surface impoundment, waste pile, landfill or other land disposal unit as defined in 40 C.F.R. 260.10. Lead painted and lead bearing materials and wastes are also regulated to limit human blood level concentrations in the exposed community to less than 10 micrograms per deciliter as required by the USEPA and OSHA, and regulated under the Clean Air Act as a hazardous air pollutant.

Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered or non-buffered acetic acid for 18 hours and then filtered through a 0.75 micron filter prior to nitric acid digestion and final ICP analyses for total “soluble” metals. The extract solution is made up from 5.7 ml of glacial acetic acid and 64.3 ml of 1.0 normal sodium hydroxide up to 1000 ml dilution with reagent water.

Suitable water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of heavy metals and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached selenium is then analyzed by Inductively-Coupled Plasma (ICP) after filtration of a 100 ml aliquot from the tumbler through a 45 micron glass bead filter.

Pb is also regulated in numerous countries as to content in air, water, wastewater and soils. Limits for allowable “total” Pb in air, water, wastewater and soils are established for the primary intent of protecting receptors such as inhalation to humans, ingestion by humans and biological community and toxicity to receptors, flora and ecological communities. Release of Pb by means other than true solution in leachate (such as sub-micron or larger particulate transport to sensitive receptors) can remain a concern even if the small particle sized Pb is not determined “hazardous” under solubility tests. A lime (CaO) treated refuse incinerator ash, for example, could pass TCLP leach testing if the final TCLP leach pH level was targeted to 9.0 units, yet this lime treated ash particulate would remain highly fugitive and exist in a toxic form as PbO or Pb3O5 . . . which is highly soluble in rainwater, de-ionized water, human and animal stomach acid, and thus readily transferred to the environment and blood serum.

Of specific interest and concern regarding the present invention is the leach test measured solubility, human and animal stomach digestible amount of lead as produced under the TCLP as well as field leachate, air and surface water contact conditions such as open industrial sites, waste storage cells, waste piles, waste mono-fills, under regulatory tests which attempt to simulate water leaching for determination of hazardousness of any given material or waste, and TCLP modified leach test using 1.0 N HCL solution in place of dilute acetic acid to demonstrate Pb solubility in the human stomach.

The present invention provides a rapid, in-place, non-destructive, non-removal, inexpensive method of reducing both the solubility and bioavailability of lead from lead painted surfaces and lead bearing materials and wastes, as well as reducing the Pb environmental release potential. Pb is controlled by the invention under TCLP, SPLP, CALWET, MEP, HCL, rainwater and surface water leaching conditions as well as under regulatory water extraction test conditions as defined by waste control regulations in Thailand, Taiwan, Japan, Canada, Mexico, Switzerland, Germany, Sweden, The Netherlands and under American Nuclear Standards for sequential leaching of wastes by de-ionized water.

Unlike the present invention, prior art has focused on reducing Pb solubility of heavy metals in wastes under simulated landfill leaching conditions such as TCLP and thus limiting costs associated with managing Pb bearing wastes as hazardous waste. These previous methods fail to consider the importance of reducing Pb solubility in human and animal stomach acid by use of a combination of stabilizer and HCL digestion-resistant complexer, thus producing a Pb bearing material or waste surface of diffusion and leach-resistant newly formed lead minerals. This new method also provides for molecular conversion of the lead material at the molecular surface without destroying or removing the lead bearing paint of material, thus allowing for the lead based paint or material surface and/or object to remain intact and in-use. This eliminates the high cost and high exposure risk associated with removing lead paint from surfaces and removing lead bearing materials such as lead painted toys, furniture, plastic toys and objects, from use in commerce and households.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial wastewater contaminated with battery plant waste, such as sulfuric acid and heavy metals by treating the waste waster with calcium carbonate, calcium sulfate, calcium hydroxide to complete a separation of the heavy metals. However, this is not for use in a solid waste situation.

### SUMMARY OF THE INVENTION

The present invention discloses a lead paint, lead solder bearing material, pipe surface, lead stearate or similar molecular level lead physical stabilized plastic, and lead bearing material or waste, stabilization method through contact of material or waste with HCL and TCLP diffusion and leach resistant stabilizing agent and complexer, and methods of application including sequence, reaction time, and dosage content of agents including water, phosphates, calcium phosphates, phosphoric acid, wet process phosphoric acid, sulfuric acid, nitric acid, hydrochloric acid, iron, chlorides, silicates, and combinations thereof which are properly chosen to complement the material constituency and desired material leaching characteristics. The stabilizing and complexing agents proven effective are provided in both in dry and wet chemical form, and thus can be contacted with the material or waste either in-line with material production or after material production in-use or with waste.

It is anticipated that the stabilizer and complexing agents can be used for both reactive and remedial actions as well as proactive Pb leaching reduction means. The preferred method of application of stabilizer and complexer would be in-place on the lead bearing surface, and thus allowed under USEPA regulations (RCRA) as totally enclosed, in-tank or exempt method of TCLP stabilization without the need for a RCRA Part B hazardous waste treatment and storage facility permit. The stabilizer surface stabilization will also allow the lead bearing object to remain in-use and no removed or destroyed due to lead content. The preferred form of stabilizer and complexer would incorporate sufficient water content and contact time to allow for Pb minerals to form. Optimal methods also incorporate sufficient reaction and product mineral formation time.

### DETAILED DESCRIPTION

Environmental regulations throughout the world such as those developed by the USEPA under RCRA and CERCLA require Pb bearing material producers to manage such materials and wastes from such materials in a manner safe to the environment and protective of human health. In response to these regulations, environmental engineers and scientists have developed numerous means to control Pb, mostly through chemical applications which convert the solubility of waste character to a less soluble form, thus passing RCRA leach tests and allowing the lead bearing wastes to be either reused on-site or disposed at local landfills without further and more expensive control means such as hazardous waste disposal landfills or facilities designed to provide Pb stabilization. The primary focus of scientists has been on reducing solubility of Pb, as this continues to be the most significant mass of contamination in soils and on materials.

There exists a demand for improved and less costly control methods of Pb and a concurrent need to limit lead bioavailability from active lead surfaces such as lead painted structures, lead bearing water supply piping, lead solder, lead bearing and physical lead stabilized plastics such as use of lead stearate and lead bearing objects.

The present invention discloses a Pb bearing material and waste stabilization and bioavailability control method through contact of the material and waste with stabilizing agents and complexer agents that are TCLP acetic acid and HCL acid digestion resistant. Agents includes water, phosphates, calcium phosphates, phosphoric acid, wet process phosphoric acid, sulfuric acid, nitric acid, hydrochloric acid, iron, chlorides, silicates and combinations thereof. The stabilizing agents found effective are available in dry, slurry and wet chemical form, and thus can be contacted with Pb bearing material in-place or after waste production in collection devices such as hoppers, dump valves, conveyors, dumpsters or waste piles. Stabilized materials such as lead painted structures, lead bearing plastic objects and toys, can remain in-use, thus avoiding the high cost of lead bearing material removal and disposal.

It is anticipated that the stabilizers and complexers can be used for RCRA compliance actions such that generated materials from lead paint abatement do not exceed appropriate TCLP hazardous waste criteria, and under TCLP or CERCLA (Superfund) response where stabilizers are added to waste piles or storage vessels previously generated. The preferred method of application of agents would be in-place within the structure using lead paint or lead piping, and thus allowed under RCRA as a totally enclosed, in-tank or exempt method of TCLP stabilization without the need for a RCRA Part B hazardous waste treatment and storage facility permit(s).

The stabilizing and complexing agents including water, phosphates, calcium phosphates, phosphoric acid, sulfuric acid, nitric acid, iron, chlorides, silicates, and combinations thereof, with the phosphate group including but not limited to wet process amber phosphoric acid, wet process green phosphoric acid, aluminum finishing Coproduct blends of phosphoric acid and sulfuric acid, technical grade phosphoric acid, monoammonia phosphate (MAP), diammonium phosphate (DAP), single superphosphate (SSP), triple superphosphate (TSP), hexametaphosphate (HMP), tetrapotassium polyphosphate, dicalcium phosphate, tricalcium phosphate, monocalcium phosphate, phosphate rock, pulverized forms of all above dry phosphates, and combinations thereof, would be selected through laboratory treatability and/or bench scale testing to provide sufficient control of Pb solubility and bioavailability. In certain cases, such as with the use of triple superphosphate, amber and green phosphoric acid, phosphates may embody sulfuric acid, vanadium, iron, aluminum and other complexing agents which could also provide for a single-step formation of complexed Pb minerals. The stabilizer and complexing agent type, size, dose rate, contact duration, and application means would be engineered for each type of Pb bearing material and waste.

Although the exact stabilization formation molecule(s) are undetermined at this time, it is expected that when Pb comes into contact with the stabilizing and complexing in the presence of reaction water and reaction time, TCLP and HCL relatively insoluble Pb mineral compounds will form such as a chloropyromorphite, plumbogummite, mineral apatites, mononuclear silicate layers, surface calcium ion exchanged apatite minerals or precipitate through substitution or surface bonding, which are less soluble than the Pb paint carbonate, lead stearate, lead oxide, or other relatively TCLP and or HCL acid soluble molecule originally in the lead painted or lead bearing material or waste. Complexing of Pb into pyromorphite amorphous crystals most likely occurs by adding calcium phosphate(s) to the material or waste at standard temperature and pressure. Complexing of chloropyromorphite will most likely occur by adding calcium phosphate(s) to the lead bearing material or waste in the presence of chlorides, or with use of chloroapatites as the calcium phosphate source, to allow for the molecular introduction of Cl into the Pb and PO4 combined structure to yield Pb(5)(PO4)3CL.

Examples of suitable stabilizing and complexing agents include, but are not limited to, water, phosphates, calcium phosphates, Phosphoric acids, Sulfuric acid, Nitric acid, Hydrochloric acid, phosphate fertilizers, phosphate rock, pulverized phosphate rock, chlorides, calcium orthophosphates, monocalcium phosphate, dicalcium phosphate, tricalcium phosphate, trisodium phosphates, silicates, sodium silicates, potassium silicates, natural phosphates, wet process green phosphoric acid, wet process amber phosphoric acid, black phosphoric acid, merchant grade phosphoric acid, aluminum finishing phosphoric and sulfuric acid solution, hypophosphoric acid, metaphosphoric acid, hexametaphosphate, tertrapotassium polyphosphate, polyphosphates, trisodium phosphates, pyrophosphoric acid, fishbone phosphate, animal bone phosphate, herring meal, bone meal, phosphorites, and combinations thereof. Salts of phosphoric acid can be used and are preferably alkali metal salts such as, but not limited to, trisodium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

The amounts of lead paint surface, lead bearing piping, lead solder, lead bearing plastic stabilizing and complexing agent used, according to the method of invention, depends on various factors including desired solubility reduction potential, desired complexed lead mineral toxicity, curing time allowance, and desired mineral formation relating to toxicological and site environmental control objectives. It has been found that a single surface wash application of 10 parts Tricalcium phosphate, 2 parts sodium chloride and 50 parts water solution by weight is sufficient to stabilize surfaces of Pb bearing paint, lead piping, lead solder, and lead bearing PVC surfaces after 24 hours curing for such surfaces to pass TCLP and HCL digestion levels at less than 5 ppm and groundwater leaching at less than 0.05 ppm. However, the foregoing is not intended to preclude yet higher or lower usage of stabilizing and complexing or combinations if needed.

The examples below are merely illustrative of this invention and are not intended to limit it thereby in any way.

### EXAMPLE 1

In this example lead painted wood surface, lead pipe solder surface, and lead stearate bearing PVC surfaces were stabilized with a weight solution of 10 parts Tricalcium Phosphate powder (TCP), 2 parts NaCL, 100 parts water, and cured 24 hours. Both stabilized and un-stabilized Pb paint and solder surface samples were subsequently tested for TCLP, HCL, and Groundwater Extract (GW). Samples were extracted according to TCLP and TCLP-HCL/TCLP-GW modified procedure set forth in Federal Register, Vol. 55, No. 126, pp. 26985-26998 (Jun. 29, 199), which is hereby incorporated by reference. The leachate was digested prior to analysis by ICP.

TABLE 1

| Stabilizer Dose (%) | TCLP-HCL-GW Pb (ppm) |
|---|---|
| Paint Baseline | 32.0-61.6-12.9 |
| Solder Baseline | 16.5-32.9-3.6 |
| PVC Baseline | 23-46-0.40 |
| Paint Stabilized | 0.06-1.4-<0.05 |
| Solder Stabilized | 0.09-2.4-<0.05 |
| PVC Stabilized | <0.05-0.88-<0.05 |

The foregoing results in Table 1 readily established the operability of the present process to stabilize and complex Pb bearing surfaces to reducing TCLP leachability and HCL digestive bioavailability and GW solubility. Given the effectiveness of the stabilizing and agglomerating agents in causing heavy metals to stabilize as presented in the Table 1, it is believed that an amount of the agents equivalent to less than 10% by weight of heavy metal bearing material or waste should be effective.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A method of reducing the TCLP solubility, HCL bioavailability and GW solubility of Pb bearing material surfaces, comprising contacting heavy metal bearing material surface with at least one stabilizing agent and one complexing agent, in an amount effective in reducing the leaching of heavy metals from the material to a level no more than non-hazardous levels as determined in an EPA TCLP test, performed on the stabilized material or waste, as set forth in the Federal Register, vol. 55, no. 126, pp. 26985-26998 (Jun. 29, 1990); and reducing HCL digestive ability as measured by a TCLP-HCL modified leach test to acceptable established regulatory levels; and reducing groundwater solubility as measured by a TCLP-GW modified leach test to acceptable established regulatory levels.

2. The method of claim 1, wherein the stabilizing and complexing agents are selected from the group consisting of water, phosphates, calcium phosphates, sulfuric acid, nitric acid, hydrochloric acid, silicates, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

3. The method of claim 2, wherein the salts of phosphoric acid are alkali metal salts.

4. The method of claim 2, wherein the phosphate salt is a trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

5. The method of claim 2, wherein the stabilizer and complexing agents are supplied as one product including triple superphosphate (TSP), wet process phosphoric acid, coproduct, and combination fertilizer mixtures with TSP.

6. The method of claim 2, wherein the complexing agents are selected from water, process water, rainwater, river water, lake water, salt water, brackish water, polymer, chlorides, calcium chloride, sodium chloride, potassium chloride, vanadium, boron, iron, aluminum, or combinations thereof.

7. The method of claim 1 wherein material or waste is contacted with at least one stabilizing and one complexing agent in effective amount to reduce leaching to TCLP non-hazardous or desired levels prior to collection of such material or waste in containers.

8. The method of claim 1 wherein material or waste is contacted with at least one stabilizing agent and one complexing agent in effective amount to reduce leaching to TCLP non-hazardous or desired levels during or after collection of such material or waste in containers or during or after generation of a regulated waste.

9. A method of claim 1 wherein reduction of solubility of Pb bearing material or waste, comprising contacting heavy metal bearing material or waste with at least one stabilizing and one complexing agent in an amount effective in reducing the leaching of Pb from the material or waste to a level no more than non-regulated levels as determined under leach tests required for hazardous waste, groundwater protection, surface water protection, and human health exposure protection regulation in countries including but not limited to United States, Switzerland, Mexico, Taiwan, Japan, Canada, China, Germany, Sweden, Denmark, Italy, Greece, Iceland, Australia, Singapore, Indonesia, Philippines, The Netherlands, France, Britain, India, South Korea, Vietnam

10. The method of claim 1 wherein material or waste includes refuse lead painted material surfaces, wood lead painted surfaces, steel lead painted surfaces, concrete lead painted surfaces, lead bearing pipe surfaces, elemental lead, lead weights, lead projectiles, lead solder, lead bearing plastics, lead stearate bearing plastics, lead bearing PVC.
